(19) United States
(12) Patent Application Publication
(10) Pub. No.: US 2007/0223049 A1
(43) Pub. Date: Sep. 27, 2007

(54) Method, apparatus, and program for displaying data

(75) Inventors: Hajime Araya, Tokyo (JP); Kei Yamaji, Tokyo (JP); Yukiko Kudo, Tokyo (JP); Koichi Tanimura, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/727,504

(22) Filed: Mar. 27, 2007

(30) Foreign Application Priority Data
Mar. 27, 2006 (JP) 2006-084917

(51) Int. Cl. G06F 15/00

(52) U.S. Cl. 358/302; 358/1.9

(57) ABSTRACT

Recognition of the contents of data, such as still images obtained by digital cameras, is facilitated. A plurality of images obtained by a digital camera are read out from a memory card. A classifying section classifies the plurality of images into groups, each of which corresponds to a date. A representative data selecting section selects a predetermined number of pieces of representative data from each of the groups. A display control section arranges thumbnail images of the predetermined number of pieces of representative data, arranged in date regions, which are classified by date, on a monitor.

### BACKGROUND OF THE INVENTION

1. Field of the Invention

The present invention relates to a method and apparatus for displaying data, such as still images, video data, and audio data obtained by digital cameras, on a display means, such as a monitor. The present invention also relates to a program that causes a computer to execute the data displaying method.

2. Description of the Related Art

Printing services are provided, in which images obtained by digital cameras are output as prints. In these printing services, printing is performed in a manner as described, for example, in Japanese Unexamined Patent Publication No. 2004-034597. That is, a user specifies images to be output as prints using image viewing software on their own personal computers. The user also generates order data that indicates the contents of an order, such as the number of prints and print sizes, records the images to be output as prints and the order data onto a medium, such as a memory card, and brings the medium to a DPE store. The medium is set within an order reception apparatus installed at the DPE store, the user operates the apparatus according to instructions which are displayed on a screen thereof, and the images are output as prints according to the contents of the order data by a printer of the DPE store.

During the aforementioned printing and recording onto the medium, it is necessary for the order reception apparatus and the like to display the images as a catalog, to select the images for which printing is to be ordered. A method for classifying images into groups, each corresponding to a date of photography, and displaying a representative image from each group on the folder thereof has been proposed in Japanese Unexamined Patent Publication No. 2005-119083. By this method, the contents of the images classified into each group can be recognized from the representative image, which facilitates selection of images for which printing is to be ordered.

However, in the method disclosed in Japanese Unexamined Patent Publication No. 2005-119083, only a single representative image is displayed. Therefore, it is difficult to know what kinds of images are in each of the groups, which are classified by date.

### SUMMARY OF THE INVENTION

The present invention has been developed in view of the foregoing circumstances. It is an object of the present invention to facilitate recognition of the contents of data, such as still images obtained by digital cameras.

A data display apparatus according to the present invention comprises:

display means;

data input means, for receiving input of a plurality of pieces of data obtained by a digital camera;

classifying means, for classifying the plurality of pieces of data into a plurality of groups, each corresponding to a date;

representative data selecting means, for selecting a predetermined number of pieces of representative data from each of the plurality of groups; and

display control means, for displaying thumbnail images of the predetermined number of pieces of representative data, arranged in date regions, which are classified by date, on the display means.

Thereby, the kinds of data which are classified into the date corresponding to the date region where thumbnail images are displayed can be easily recognized, by viewing the thumbnail images.

Note that a configuration may be adopted, wherein:

the display control means displays dates corresponding to the predetermined number of pieces of representative data, and additional data that includes the numbers of still images, video data, and audio data classified in the group corresponding to the dates, in the case that the plurality of pieces of data include still images, video data, and audio data.

In this case, the date that the classified data were obtained, and the numbers of still images, video data, and audio data classified into that date can be easily recognized, by referring to the additional data.

A configuration may be adopted, wherein:

the representative data selecting means sorts the plurality of pieces of data in order of obtainment, and selects at least one piece of data from each of the beginning and the end of the order, until the predetermined number of pieces of representative data is selected.

In this case, it becomes easy to recognize what types of data are classified in the group corresponding to a date.

A configuration may be adopted, wherein:

the classifying means classifies the pieces of data, which are classified into each of the plurality of groups, into a number of subgroups equal to the predetermined number, based on temporal differences in the order of obtainment thereof; and

the representative data selecting means selects a piece of data from each of the predetermined number of subgroups as the representative data.

In this case, representative data can be selected evenly from among the data which are classified by date.

A configuration may be adopted, wherein:

the classifying means classifies the pieces of data, which are classified into each of the plurality of groups, into a number of subgroups of similar images greater than or equal to the predetermined number, in the case that the pieces of data are still images; and

the representative data selecting means selects a piece of data from the subgroups, based on evaluation values regarding the image quality of the still images within the subgroups, as the representative data.

In this case, representative data can be selected evenly from among the data which are classified by date.

Alternatively, a configuration may be adopted, wherein:

the classifying means classifies the pieces of data, which are classified into each of the plurality of groups, into a number of subgroups equal to the predetermined number, based on temporal differences in the order of obtainment thereof; and

the representative data selecting means selects a piece of data having the highest evaluation value regarding the image quality thereof from each subgroup, as the representative data.

A configuration may be adopted, wherein;

the display control means displays the first frame of a video data file as the thumbnail image, in the case that the piece of representative data is video data.

In this case, the contents of a piece of video data, which is selected as the piece of representative data, can be easily recognized.

A configuration may be adopted, wherein;

the display control means obtains a plurality of frames of a video data file, arranges the frames, and displays them as a single thumbnail image, in the case that the piece of representative data is video data.

In this case, the contents of a piece of video data, which is selected as the piece of representative data, can be easily recognized.

A configuration may be adopted, wherein the data display apparatus further comprises:

selecting means, for selecting all images within a group corresponding to a date region, if selection of a date region is received.

In this case, pieces of data, which have been classified by date, can be easily selected.

In addition, a configuration may be adopted, wherein:

the display control means displays a catalog of the images within the group corresponding to the selected date region, in such a manner that images which are similar to each other and unnecessary image candidates are distinguishable.

In this case, selection of data to be output as prints and data to be discarded can be facilitated during the catalog display.

A data display method of the present invention comprises the steps of:

receiving input of a plurality of pieces of data obtained by a digital camera;

classifying the plurality of pieces of data into a plurality of groups, each corresponding to a date;

selecting a predetermined number of pieces of representative data from each of the plurality of groups; and

displaying thumbnail images of the predetermined number of pieces of representative data, arranged in date regions, which are classified by date, on a display means.

The data display method may be provided as a program that causes a computer to execute the method.

Note that the program of the present invention may be provided being recorded on a computer readable medium. Those who are skilled in the art would know that computer readable media are not limited to any specific type of device, and include, but are not limited to: floppy disks, CD's, RAM's, ROM's, hard disks, magnetic tapes, and internet downloads, in which computer instructions can be stored and/or transmitted. Transmission of the computer instructions through a network or through wireless transmission means is also within the scope of the present invention. Additionally, computer instructions include, but are not limited to: source, object, and executable code, and can be in any language, including higher level languages, assembly language, and machine language.

### BRIEF DESCRIPTION OF THE DRAWINGS

FIG. 1 is a perspective view of the exterior of an order reception apparatus, to which a data display apparatus according to a first embodiment of the present invention has been applied.

FIG. 2 is a schematic block diagram that illustrates the construction of the order reception apparatus according to the first embodiment.

FIG. 3 is a flow chart that illustrates the steps of the process performed by the order reception apparatus according to the first embodiment.

FIG. 4 is a diagram that illustrates an example of a classified screen of the first embodiment.

FIG. 5 is a diagram that illustrates an alternate date region.

FIG. 6 is a diagram that illustrates an alternate date region,

FIG. 7 is a diagram that illustrates an alternate date region.

FIG. 8 is a diagram that illustrates an alternate date region.

FIG. 9 is a first diagram that illustrates a data catalog screen.

FIG. 10 is a second diagram that illustrates the data catalog screen.

### DESCRIPTION OF THE PREFERRED EMBODIMENTS

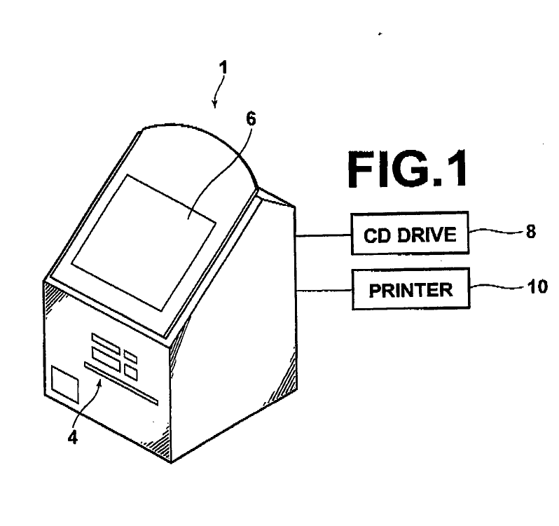

Hereinafter, an embodiment of the present invention will be described with reference to the attached drawings. FIG. 1 is a perspective view of the exterior of an order reception apparatus 1 (hereinafter, simply referred to as “apparatus 1”), to which the data display apparatus according to the embodiment of the present invention has been applied. The apparatus 1 is installed at a DPE store in order to receive orders from users to record images onto CD's, to output images as prints, and the like. As illustrated in FIG. 1, the apparatus 1 comprises: a plurality of types of card slots 4, into which various types of memory cards 2 are loaded to read and write data from and onto the memory cards 2; and a display section 6, for performing various types of display during the course of placing orders. The order reception apparatus 1 is connected to a CD drive 8 and a printer 10, which are also provided in the DPE store. Note that the display section 6 comprises a touch panel type input section. Users are enabled to perform input necessary to place orders, by touching the display section 6 in response to instructions displayed thereon.

Here, a case will be described in which a user orders recording of data, which is recorded on a memory card 2, onto a CD.

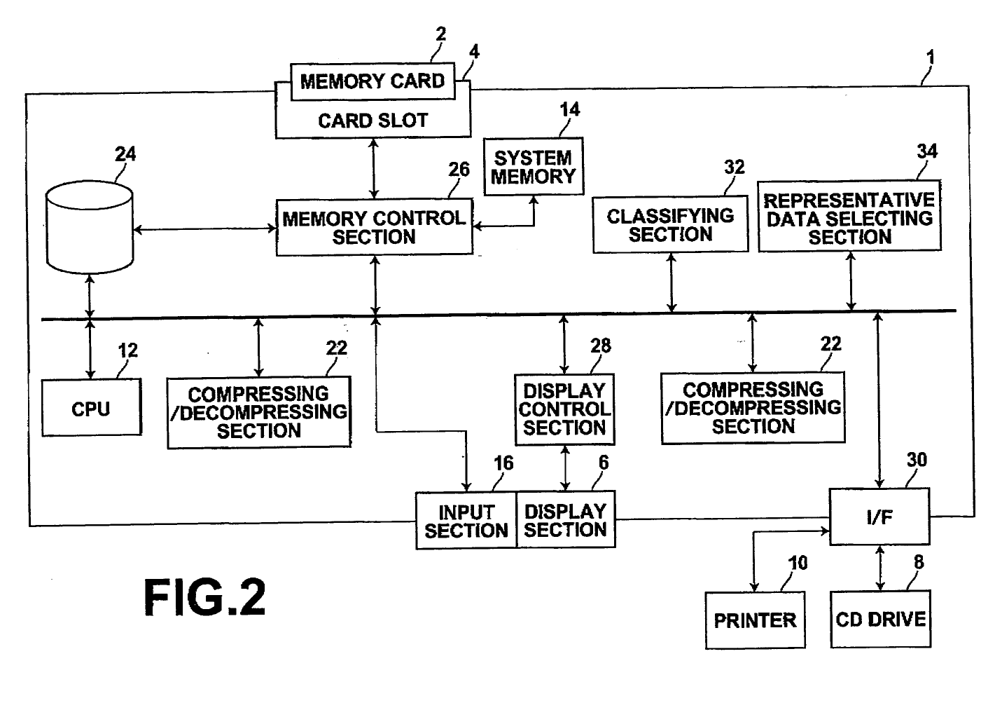

FIG. 2 is a schematic block diagram that illustrates the construction of the apparatus 1. As illustrated in FIG. 2, the order reception apparatus 1 comprises: a CPU 12, for controlling recording of data which is read out from the memory card 2, as well as the other components of the apparatus 1; a system memory 14, constituted by a ROM, in which basic programs for operating the apparatus 1 and various constants are recorded, and a RAM, which functions as a workspace for the CPU 12 during execution of processes thereby; a touch panel type input section 16, for inputting various types of commands to the apparatus 1; and the aforementioned display section 6.

The apparatus 1 further comprises: the aforementioned card slots 4; a compressing/decompressing section 22, for compressing still images and video data into formats such as JPEG and Motion JPEG and for decompressing compressed data; a hard disk 24, in which an ordering program for processing orders to record data read out from the memory card 2 onto a CD and the like, and various other programs to be executed by the CPU 12 are recorded; a memory control section 26, for controlling the card slots 4 and the hard disk 24; a display control section 28, for controlling display by the display section 6; and an interface 30 for connecting the apparatus 1 to the CD drive 8 and the printer 10.

Note that a plurality of card slots 4 corresponding to various types of memory cards 2 are provided. However, only a single card slot 4 is illustrated in FIG. 1 and FIG. 2.

The apparatus 1 further comprises: a classifying section 32, for classifying a plurality of pieces of data recorded on the memory card 2 into groups, each corresponding to a data of obtainment; and a representative data selecting section 34, for selecting a plurality of pieces of representative data from each of the groups.

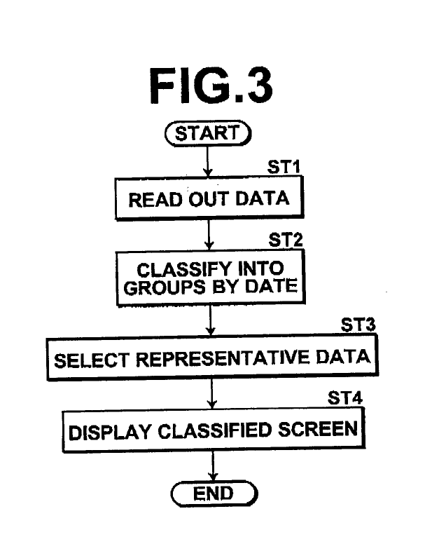

Hereinafter, the process performed by the apparatus 1 of the present embodiment will be described. FIG. 3 is a flow chart that illustrates the steps of the process performed by the apparatus 1 of the present embodiment. The user loads the memory card 2 into the card slot 4, and the plurality of pieces of data recorded in the memory card 2 are read out by the CPU 12 initiating processing in response to a readout command input through the input section 16 (step ST1). Next, the classifying section 32 classifies the read out plurality of pieces of data into groups, each corresponding to the date of obtainment thereof (step ST2). Specifically, data which have been obtained on the same day are classified into the same group. Note that the classification into groups corresponding to the dates of obtainment can be performed by employing data indicating the date of obtainment, attached to still images, video data, and audio data.

Thereafter, the representative data selecting section 34 selects a plurality of pieces of representative data from among the data classified into each of the groups (step ST3) Then, the display control section 28 causes a classified screen, in which thumbnail images of the representative data are arranged within date regions, to be displayed by the display section 6 (step ST4), and the process ends.

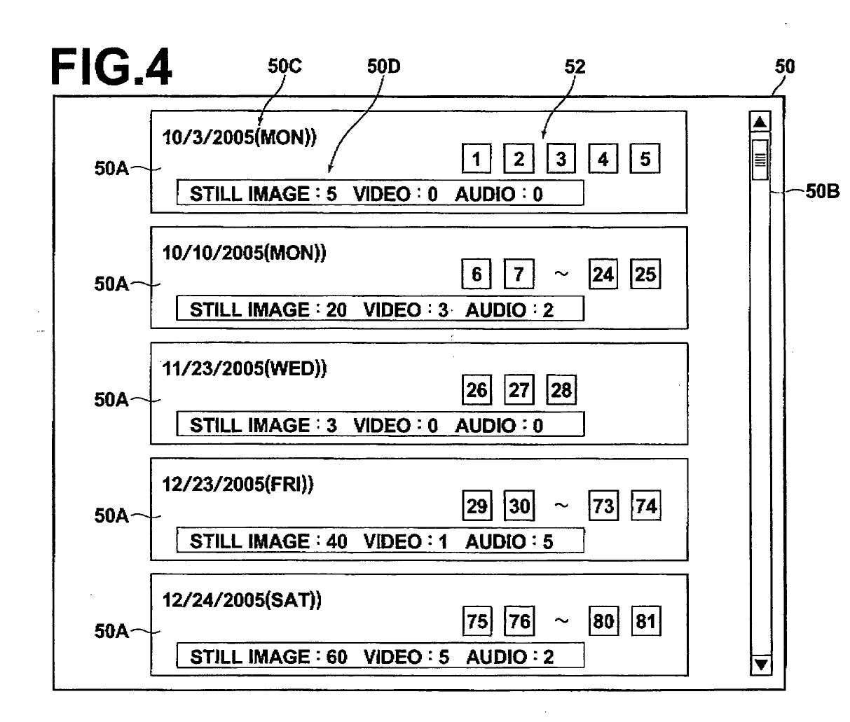

FIG. 4 is a diagram that illustrates an example of the classified screen of the present embodiment. As illustrated in FIG. 4, a plurality of date regions 50A and a scroll bar 50B, for scrolling through the date regions 50A are displayed in the classified screen 50. The date 50C that the data were obtained and additional data SOD that indicates the numbers of still images, video data, and audio data obtained on the date 50C are displayed in each date region 50A. Here, a case will be described in which 81 pieces of data have been classified, and the ordinal numbers of the pieces of data are employed to label thumbnail images 52 displayed in the classified screen 50.

Note that in the case that the representative data are still images, reduced images of the still images may be employed as the thumbnail images 52. In the case that the representative data are video data, reduced images of the first frames thereof may be employed as the thumbnail images 52. Note that the thumbnail images 52 of video data may alternatively be central frames or final frames thereof. In the case that the representative data are audio data, icons that indicates that the representative data are audio data may be employed as the thumbnail images 52.

In the present embodiment, four or five pieces of representative data are selected from each group, and four or five thumbnail images 52 of the representative data are displayed in each date region 50A. Hereinafter, selection and display of the representative data will be described in detail.

First, in the case that there are five or less pieces of data which are classified into a single group, all of the pieces of data are selected as pieces of representative data, and thumbnail images 52 thereof are displayed. Specifically, in the case that five pieces of data are classified in a single group, five thumbnail images 52 are displayed, as illustrated in the date region 50A corresponding to 10/3/2005. In the case that three pieces of data are classified in a single group, three thumbnail images 52 are displayed, as illustrated in the date region 50A corresponding to 11/23/2005.

In the case that six or more pieces of data are classified into a single group, the pieces of data are sorted in order of obtainment, the first two and the last two pieces of data in the order are selected as the pieces of representative data, and thumbnail images 52 of the four pieces of representative data are displayed. At this time, a line “˜” is displayed between the first two thumbnail images 52 and the last two thumbnail images 52, to indicate that other pieces of data exist between the representative data. Specifically, four thumbnail images 52 are displayed in the manner illustrated in the date regions 50A corresponding to 10/10/2005, 12/23/2005, and 12/24/2005.

In this manner, the present embodiment displays the plurality of thumbnail images 52 within the date regions 50A of the classified screen 50. Thereby, the kinds of data which are classified into the dates corresponding to the date regions 50A where the thumbnail images 52 are displayed can be easily recognized, by viewing the thumbnail images 52.

In addition, the additional data 50D that includes the numbers of still images, video data, and audio data classified in the groups corresponding to the dates is displayed in each of the date regions 50A. Thereby, the date that the classified data were obtained, and the numbers of still images, video data, and audio data classified into that date can be easily recognized, by referring to the additional data SOD.

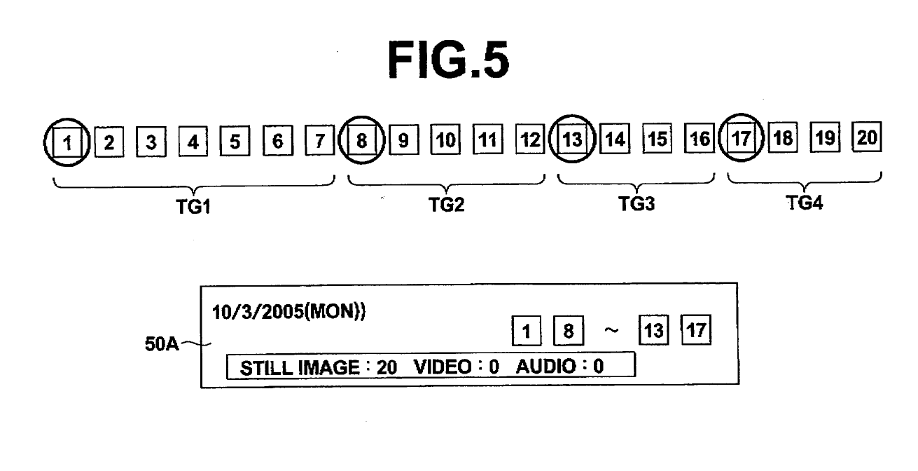

Note that the pieces of representative data may alternatively be selected by further classifying the pieces of data, which are classified into each of the plurality of groups by date, into a four subgroups TG1, TG2, TG3, and TG4, based on temporal differences in the order of obtainment thereof, as illustrated in FIG. 5. Then, the first piece of data in each of the four subgroups TG1, TG2, TG3, and TG4 (data numbered 1, 8, 13, and 17 in the example of FIG. 5) is selected as the representative data. In this case, classification into the subgroups TG1, TG2, TG3, and TG4 may be accomplished by sectioning the group into the subgroups at the three greatest differences in the times of obtainment of the pieces of data.

In FIG. 5, a line “˜” is displayed between the two thumbnail images 52 of data 1, 8 and the two thumbnail images 52 of data 13, 17, to indicate that other pieces of data exist between the representative data. Alternatively, the four thumbnail images 52 may be displayed without the line therebetween. As a further alternative, the group may be classified into five subgroups, and five thumbnail images 52 may be displayed in the date region 50A.

Particularly in the case that all of the pieces of data classified into a single group are still images, the pieces of data within the group may be classified into subgroups of similar images. In this case, evaluation values are calculated for each piece of data (still image) within the subgroups, based on the degrees of focus thereof, and an average evaluation value is calculated for each subgroup. Then, the subgroups are sorted in order of the highest average evaluation value, the top four subgroups are selected, and pieces of data having the highest evaluation values from within the selected subgroups are selected as the pieces of representative data.

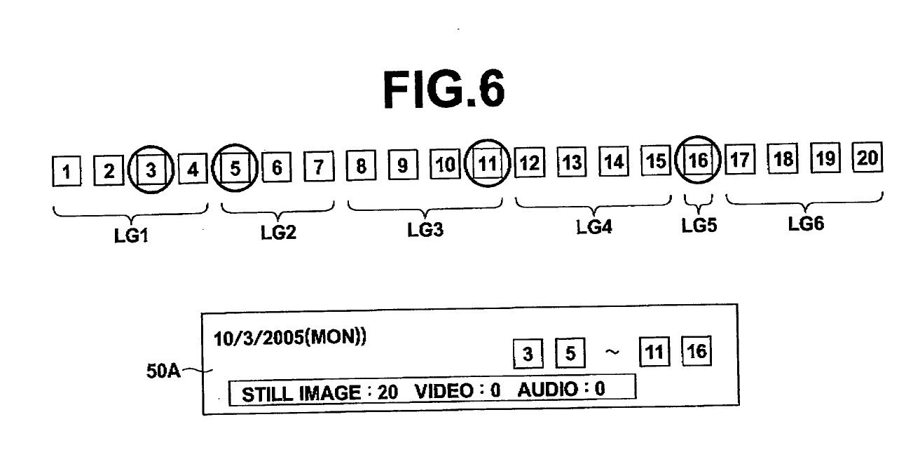

Specifically, in the case that 20 pieces of data representing still images are classified into a single group as illustrated in FIG. 6, scene analysis is performed for each piece of data, and the pieces of data are classified into six subgroups LG1 through LG6 comprising similar data. Then, evaluation values are calculated for each piece of data (still image) within the subgroups LG1 through LG6, based on the degrees of focus thereof, and an average evaluation value is calculated for each subgroup. Here, if the average evaluation values of the subgroups LG1 through LG6 are 60, 80, 65, 35, 95, and 10, respectively, the four subgroups having the highest average evaluation values, that is, subgroups LG1, LG2, LG3, and LG5 are selected. Thereafter, the piece of data having the highest evaluation values from within each of the selected subgroups LG1, LG2, LG3, and LG5 (data numbered 3, 5, 11, and 16 in the example of FIG. 6) are selected as the pieces of representative data.

Note that in the case that there are five or less subgroups, a single piece of representative data may be selected from each of the subgroups, and thumbnail images 52 thereof may be displayed in the date region 50A.

The pieces of data, which are classified into each of the plurality of groups by date, may be further classified into a number of subgroups, based on temporal differences in the order of obtainment thereof. Thereafter, a piece of data having the highest evaluation value within each subgroup may be selected as the representative data, and thumbnail images thereof may be displayed in the date region 50A.

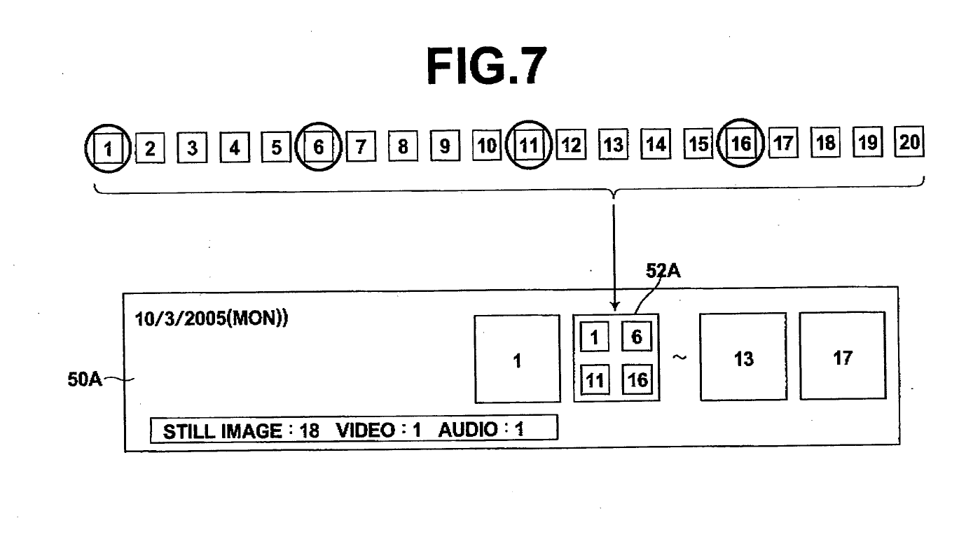

In the present embodiment, in the case that the representative data is video data, frames of the video data may be divided equally into four, and thumbnail images 52 of the first frame of each division may be displayed in the date region 50A. Specifically, in the case that a piece of video data is constituted by 20 frames, as illustrated in FIG. 7, the 20 frames may be divided into four groups of five frames each. Then, the first frame of each group (frames 1, 6, 11, and 16) are selected. Thumbnail images 52 of the selected frames 1, 6, 11, and 16 are generated, and displayed in the date region 50A along with other thumbnail images 52.

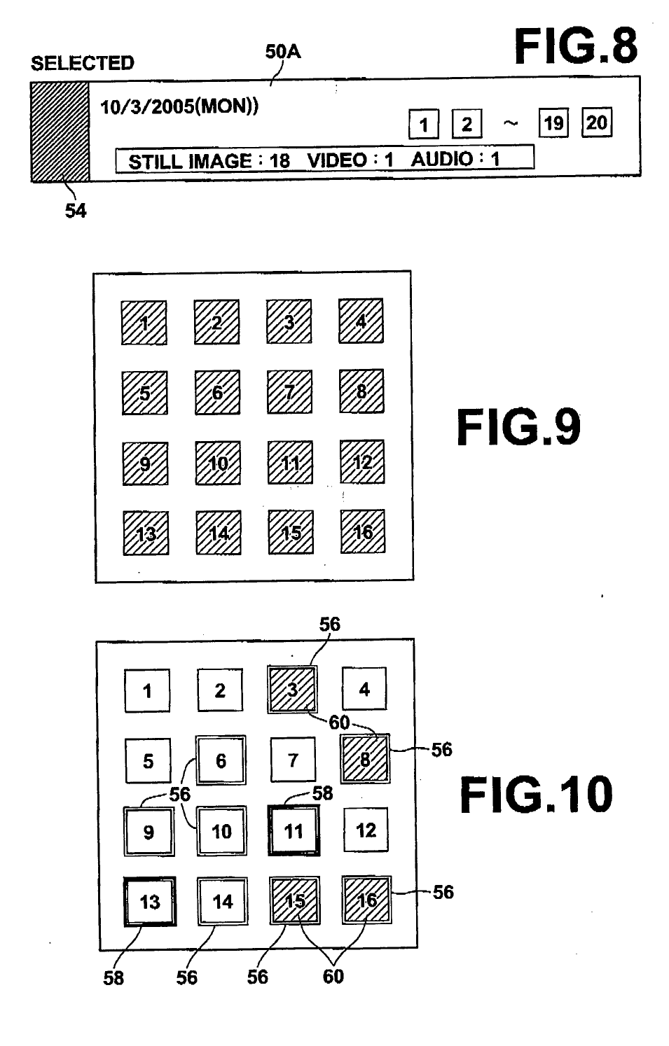

The user selects images to be recorded onto the CD while the classified screen 50 is being displayed by the display section 6. At this time, each of the date regions 50A is configured to be selectable from within the classified screen 50. When a date region 50A is selected, all of the pieces of data classified in the group corresponding to the date are selected. Note that a mark 54 that indicates that a date region 50A has been selected may be displayed after the date region 50A is selected, as illustrated in FIG. 8. Thereby, the operation of displaying a catalog of the pieces of data for each date and selecting pieces of data from the catalog can be simplified, and the burden on the user can be lightened.

Note that a command for catalog display may be input in a state that a date region 50A is selected. Thereby, the catalog of the pieces of data classified in the group corresponding to the date is displayed, in a state that all of the pieces of data are selected, as illustrated in FIG. 9. In FIG. 9, the hatching through the thumbnail images of the data displayed in the catalog indicate the selected state.

At this time, the pieces of data within the group may be classified into subgroups of similar images. Data that indicate that pieces of data are similar to each other may be added to the catalog display screen. In addition, evaluation values may be calculated for each piece of data within the subgroups, based on the degrees of focus thereof, and data indicating that pieces of data are candidates for removal may be added to those having evaluation values less than or equal to a predetermined value.

For example, the same frames 56 and 58 may be provided around similar pieces of data, and hatching 60 may be provided to candidate images for removal, as illustrated in FIG. 10. Specifically, in the example of FIG. 10, thumbnail images numbered 3, 6, 8, 9, 10, 14, 15, and 16 are surrounded by the frame 56, thumbnail images numbered 11 and 13 are surrounded by the frame 58, and hatching 60 is provided through thumbnail images numbered 3, 8, 15, and 16. Thereby, selection of data to be output and data to be discarded, from a state in which all of the pieces of data are selected, can be facilitated during the catalog display.

An apparatus according to an embodiment of the present invention has been described above. A program that causes a computer to function as the classifying section 32, the representative data selecting section 34, and the display control section 28 to perform the process illustrated in FIG. 3 is also an embodiment of the preset invention. A computer readable medium in which such a program is recorded is also an embodiment of the present invention. Such a program may also be incorporated in image viewing software, for viewing images.

What is claimed is:

1. A data display apparatus, comprising;
display means;
data input means, for receiving input of a plurality of pieces of data obtained by a digital camera;
classifying means, for classifying the plurality of pieces of data into a plurality of groups, each corresponding to a date;
representative data selecting means, for selecting a predetermined number of pieces of representative data from each of the plurality of groups; and
display control means, for displaying thumbnail images of the predetermined number of pieces of representative data, arranged in date regions, which are classified by date, on the display means.

2. A data display apparatus as defined in claim 1, wherein:
the display control means displays dates corresponding to the predetermined number of pieces of representative data, and additional data that includes the numbers of still images, video data, and audio data classified in the group corresponding to the dates, in the case that the plurality of pieces of data include still images, video data, and audio data.

3. A data display apparatus as defined in claim 1, wherein:
the representative data selecting means sorts the plurality of pieces of data in order of obtainment, and selects at least one piece of data from each of the beginning and the end of the order, until the predetermined number of pieces of representative data is selected.

4. A data display apparatus as defined in claim 1, wherein:
the classifying means classifies the pieces of data, which are classified into each of the plurality of groups, into a number of subgroups equal to the predetermined number, based on temporal differences in the order of obtainment thereof; and
the representative data selecting means selects a piece of data from each of the predetermined number of subgroups as the representative data.

5. A data display apparatus as defined in claim 1, wherein:
the classifying means classifies the pieces of data, which are classified into each of the plurality of groups, into a number of subgroups of similar images greater than or equal to the predetermined number, in the case that the pieces of data are still images; and
the representative data selecting means selects a piece of data from the subgroups, based on evaluation values regarding the image quality of the still images within the subgroups, as the representative data.

6. A data display apparatus as defined in claim 1, wherein:
the classifying means classifies the pieces of data, which are classified into each of the plurality of groups, into a number of subgroups equal to the predetermined number, based on temporal differences in the order of obtainment thereof; and
the representative data selecting means selects a piece of data having the highest evaluation value regarding the image quality thereof from each subgroup, as the representative data.

7. A data display apparatus as defined in claim 1, wherein:
the display control means displays the first frame of a video data file as the thumbnail image, in the case that the piece of representative data is video data.

8. A data display apparatus as defined in claim 1, wherein:
the display control means obtains a plurality of frames of a video data file, arranges the frames, and displays them as a single thumbnail image, in the case that the piece of representative data is video data.

9. A data display apparatus as defined in claim 1, further comprising:
selecting means, for selecting all images within a group corresponding to a date region, if selection of a date region is received.

10. A data display apparatus as defined in claim 9, wherein:
the display control means displays a catalog of the images within the group corresponding to the selected date region, in such a manner that images which are similar to each other and unnecessary image candidates are distinguishable.

11. A data display method, comprising the steps of:
receiving input of a plurality of pieces of data obtained by a digital camera;
classifying the plurality of pieces of data into a plurality of groups, each corresponding to a date;
selecting a predetermined number of pieces of representative data from each of the plurality of groups; and
displaying thumbnail images of the predetermined number of pieces of representative data, arranged in date regions, which are classified by date, on a display means.

12. A program that causes a computer to execute a data display method, comprising the procedures of;
receiving input of a plurality of pieces of data obtained by a digital camera;
classifying the plurality of pieces of data into a plurality of groups, each corresponding to a date;
selecting a predetermined number of pieces of representative data from each of the plurality of groups; and
displaying thumbnail images of the predetermined number of pieces of representative data, arranged in date regions, which are classified by date, on a display means.

13. A computer readable medium having the program defined in claim 12 recorded therein.
